(19) United States
(12) Patent Application Publication
(10) Pub. No.: US 2012/0004581 A1
(43) Pub. Date: Jan. 5, 2012

(54) ROBOT MOTOR REHABILITATION DEVICE

(75) Inventor: Piero Dinon, Induno Olona (IT)

(73) Assignee: M.P.D. S.R.L., Induno Olona (IT)

(21) Appl. No.: 13/138,617

(22) PCT Filed: Mar. 12, 2010
(86) PCT No.: PCT/EP2010/001569

§ 371 Date: Sep. 12, 2011

(30) Foreign Application Priority Data
Mar. 20, 2009 (IT) MI2009A000435

(51) Int. Cl. A61H 1/02

(52) U.S. Cl. 601/23

(57) ABSTRACT

A robot rehabilitation device, especially suitable for being used in motor rehabilitation activities on patients suffering from neurological and/or orthopaedic damages of a various nature as well as motor rehabilitation on patients with a hip or knee prosthesis, including a portal structure fixed to a base structure, a motor-driven belt suitable for allowing patient to walk, a bodice basically provided with four straps or braces that can be hooked to the device structure and worn by the patient, for the support thereof, a first exoskeleton and a second exoskeleton articulated and independent for the passive and assisted movement of the lower limbs of the patient, the exoskeletons including automatic actuation and movement elements, with the rehabilitation device that further includes a device for lifting the patient for the automatic and continuous control of the amount of weight of the same to be used in the therapy.

The present invention relates to a robot motor rehabilitation device.

More in particular, the present invention relates to a robot orthotic device, especially suitable for being used in motor rehabilitation activities on patients suffering from suffering from neurological and/or orthopaedic damages of a various nature (outcomes of ictus, head traumas, vertebral column injuries) as well as motor rehabilitation on patients with a hip bone or knee prosthesis.

As is known, pathologies like ictus and other brain or vertebral column traumas, neurological and/or orthopaedic dysfunctions such as multiple sclerosis or operations for the application of hip bone or knee prosthesis may cause motor dysfunctions to the lower limbs and/or the individual's inability to properly carry out the movement.

Individuals suffering from said or similar motor pathologies may regain the functionality of their limbs or relieve the pains caused by the pathologies through the use of different physiotherapy techniques and devices.

Such techniques are physical exercises that the physiotherapist has the individual do in order to stimulate the work of those muscles injured by the trauma.

To carry out such physical exercises, the physiotherapist may use multiple devices, such as for example electrical orthopaedic walkers provided with motor-driven belt, handrail, corsets and/or slings suitable for supporting the individual partially or totally relieving the weight and preventing falls of the same.

Some known techniques envisage, moreover, also the use of electrodes applied or inserted in the individual's skin and suitable for reactivating the connection with the brain to obtain the muscle contraction.

These structures or devices, however, always require the presence of one or more persons in charge like physiotherapists that carefully follow, check and help the individual or patient in carrying out the movement. However, notwithstanding his/her skills, the physiotherapist is not able to always reproduce the movement of the injured limbs in an even and constant manner over time. Moreover, to assist a patient during his/her rehabilitation activity, the presence of at least two physiotherapists is always required, one per limb, working in synchronism with control and assistance functions in the proper execution of the movement.

The rehabilitation process therefore is long and burdensome, not just for the patient but also for the physiotherapists who assist and follow the same during this activity; in fact, guiding and controlling the movement of the patient's limbs, besides being burdensome, must also be carried out in a quick and continuous manner, with the consequence that the rehabilitation sessions required to obtain satisfactory results must be multiple and at the same time, of a limited duration.

To obviate these drawbacks, automatic and robot rehabilitation devices have been devised to be used with the motor-driven belts or walkers that assist the movement of the lower limbs during the walk; on the one side, this allows using a single physiotherapist per patient and on the other side, it makes the rehabilitation process faster since the robot device allows repeating the movements in an even and constant manner over time.

The robot orthotic devices for rehabilitating the lower limbs currently present on the market typically exhibit a walking portion with motor-driven belt sometimes provided with side handrails and a column structure provided with a patient lifting and support apparatus consisting of a corset or sling; the lifting generally takes place by means of ropes and pulley devices. The above robot devices, moreover, are provided with exoskeletons to be applied to the patient's lower limbs to carry out the movement thereof. The sensors applied to the device allow measuring and monitoring the walking activity carrying out a feedback action.

However, such robot walking devices are very cumbersome as regards the size and require large spaces for their positioning and for the management/movement of the patient during the step of insertion of the patient on board of the machine itself; in fact, if the patient is on a wheelchair, the orthotic device must be provided with a ramp to allow the patient to climb on the walker or motor-driven belt with the wheelchair in order to hook him/her, through the bodice or sling, to the device for lifting and supporting the same individual, partially or totally relieving the weight and preventing falls of the same.

The same devices, moreover, have a considerable construction complexity as regards the motion transmission and handling and require the use and the application of multiple external sensors aimed at a feedback activity, and as a consequence they are very expensive and with very complex control logics; also the maintenance and/or fixing activity in the event of a failure or fault is complex and expensive.

A further drawback is that at present, the known robot rehabilitation devices do not allow the controlled movement of the ankle rotation, or they do not allow adequately controlling the foot position during the walking cycle steps.

A further drawback of the traditional devices is that they do not allow an automatic adaptation of the patient's biometric parameters, such as height, weight, distance between the throcanters and lower limb segment length, with a precise reproduction of the same at each subsequent session.

The object of the present invention is to obviate the drawbacks discussed hereinabove.

More in particular, the object of the present invention is to provide a robot motor rehabilitation device for the movement re-education of the lower limbs which should have compact dimensions, be easy to use for both the patient and the physiotherapist who controls the same patient.

A further object of the present invention is to provide a robot rehabilitation device which should allow carrying out the controlled movement of the ankle rotation.

A further object of the present invention is to provide a rehabilitation device which should allow carrying out the automatic adaptation of the biometric parameters of the patient under treatment, such as height, weight, lower limb segment length, etc.

A further object of the present invention is to provide a robot rehabilitation device which should be flexible and safe and such as to allow an immediate management of the conditions in which the patient under treatment autonomously carries out movements with the limbs.

A further object of the present invention is to provide a robot rehabilitation device easy to maintain, inspect and for which the replacement of any worn or faulty components should be simple and easy.

A further object of the present invention is to provide the users with a robot motor rehabilitation device for lower limbs suitable for ensuring a high level of resistance and reliability over time, and also such as to be easily and inexpensively constructed.

These and other objects are achieved by the robot motor rehabilitation device for lower limbs of the present invention, which comprises a portal structure fixed to a base structure, a motor-driven belt suitable for allowing the walk of the patient, a bodice preferably provided with four straps or braces fixed to the device structure and worn by the patient for the support thereof, a first exoskeleton and a second exoskeleton articulated and independent for the passive and assisted movement of the patient's lower limbs, the exoskeletons comprising automatic actuation and movement means and with said rehabilitation device that integrates means for lifting the patient and for the automatic and continuous control of the weight management of the same.

The construction and functional features of the robot motor rehabilitation device of the present invention shall be better understood from the following detailed description, wherein reference is made to the annexed drawings showing a preferred and non-limiting embodiment thereof, and wherein:

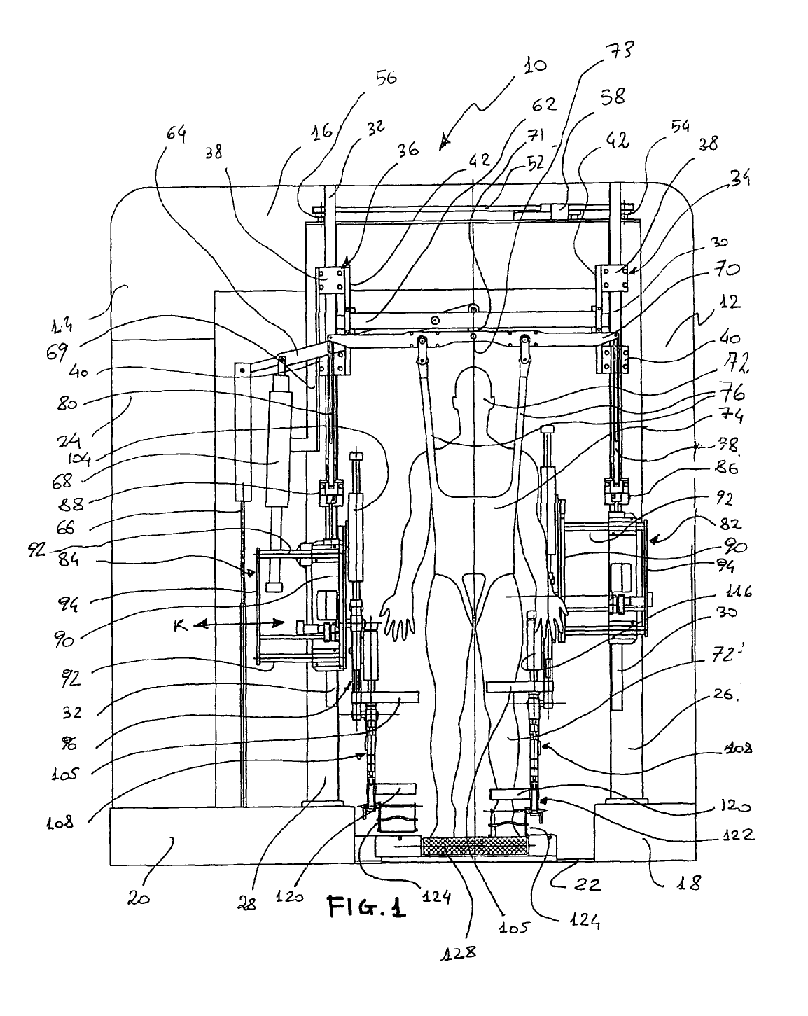

FIG. 1 shows a schematic front view of the robot motor rehabilitation device of the invention;

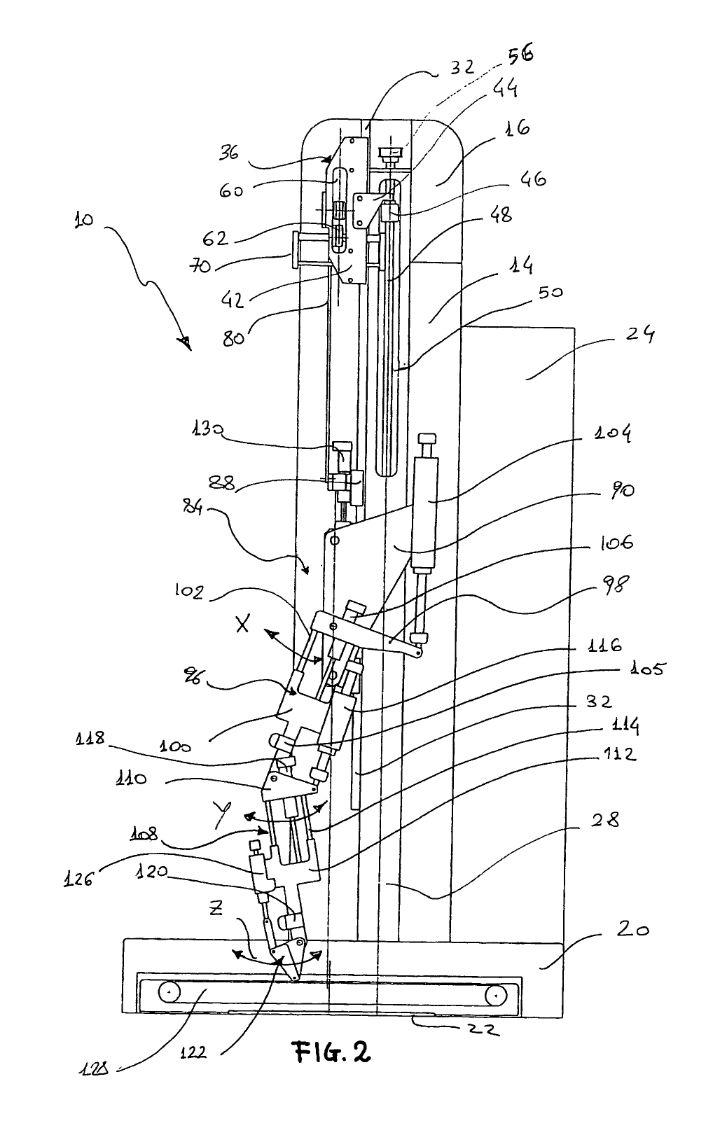

FIG. 2 shows a schematic side view of the same device.

With reference to said figures, the robot motor rehabilitation device of the present invention, globally indicated with reference numeral 10 in FIGS. 1 and 2, comprises a portal structure consisting of two vertical box bodies 12 and 14 and a horizontal covering or box 16 arranged on said vertical boxes and connected to the same by bolting or other known constraining means. Said vertical 12 and 14 and horizontal 16 box structures consist of internally hollow section bars made of steel, aluminium or other known material suitable for the purpose.

The vertical box structures 12 and 14 exhibit the ends opposite those connected to the horizontal box structure 16 stabilised to a base structure and respectively to a first foot 18 and to a second foot 20 connected to each other at the bottom by a base plate 22 placed in contact with the ground or flooring and the function whereof shall be detailed hereinafter.

The base structure is equally made from section bars or bars made of steel, aluminium or other material suitable for the purpose welded to one another or constrained in other known way.

The vertical box structure 14 is completed at the bottom by an electrical cabinet 24 wherein there are housed all the electrical and electronic components required for the operation of the device of the invention.

A first bearing column 26 and a second bearing column 28 are positioned inside the portal structure, suitable for supporting and sliding the elements that shall be described hereinafter. Said first bearing column 26 and second bearing column 28, preferably but non-exclusively with square section, are respectively fixed by the bottom end to the top front of the first foot 18 and of the second foot 20 and by the top end to the bottom front of the horizontal box structure 16 of the portal structure.

A first guide 30 and a second guide 32 are respectively fixed to the first bearing column 26 and to the second bearing column 28 and extend by a length slightly shorter than that of said bearing columns. Such first guide 30 and second guide 32 define lanes for the sliding of members which shall be explained in detail hereinafter with reference to the construction and functional features thereof.

A first carriage 34 and a second carriage 36 are respectively slidingly arranged in vertical on the first guide 30 and on the second guide 32 of the first bearing column 26 and of the second bearing column 28.

In the preferred embodiment of the figures, said first and second carriage, which exhibit the same geometrical features, are each formed by two square plates 38 and 40, the inner front whereof slides relative to the first and second guide, laterally connected by a shoulder 42 whereon a hook plate 44 is constrained, suitable for transmitting the vertical motion induced by a crosspiece 46 provided with nut screws, in turn vertically moved by two worm screws 48 arranged within each bearing column. To this end, both the first bearing column 26 and the second bearing column 28 are provided with an opening 50 made along the inner side surface and longitudinally extended for allowing the vertical sliding of the elements that shall be described hereinafter.

A gear motor, not shown in the figures, actuates the simultaneous rotation of the worm screws 48 by means of a belt transmission 52, basically of the toothed type, fitted on two pulleys 54 and 56 arranged at the top ends of screws 48; said belt 52 is further provided with a traditional belt tightening device 58

Shoulder 42 of the first carriage 34 and of the second carriage 36 is provided with a slot 60 extended in longitudinal direction which defines the seat for the vertical movement of at least one horizontal bar 62 arranged between the shoulders of said first and second carriage; in the preferred embodiment, the horizontal bars 62 are two, parallel to each other and identical.

A multiplying lever 64, hinged between the two horizontal bars 62, crosses slot 60 of shoulder 42 of the second carriage 36 and a counterweight 66 is hinged at the outer end, in the proximity whereof a linear electrical motor 68 is hinged by means of a fork or in another known manner. Said linear motor 68 is in turn pivoted on a steel support 69 afferent to plates 38 and 40 arranged on the side of the second bearing column 28.

A yoke 70 is constrained to the inner end of the multiplying lever 64 by a connecting rod 71 and freely oscillating or floating relative thereto by means of a rotation pin or fulcrum 73.

The assembly consisting of the first carriage 34, of the second carriage 36, of the horizontal bar(s) 62, of lever 64 (including the linear electrical motor 68 and counterweight 66) and of yoke 70 defines a lifting apparatus for a patient 72 that must be subject to the motor rehabilitation operation or session. For the lifting operation and subsequent support during the rehabilitation session, the patient wears a bodice 74 hooked to yoke 70 preferably by means of four straps or braces 76.

A first tie rod 78 and a second tie rod 80, arranged at the ends of yoke 70, respectively connect a first exoskeleton 82 and a second exoskeleton 84, to said yoke 70 of the lifting apparatus.

A third carriage 86 and a fourth carriage 88, respectively fixed to the first tie rod 78 and to the first exoskeleton 82, to the second tie rod 80 and to the second exoskeleton 84, are respectively slidingly arranged relative to the first guide 30 and to the second guide 32 of the bearing columns; each exoskeleton, moreover, is provided with a further carriage slidingly arranged relative to the guides and not shown in the figures. In this way it is possible to control the vertical position of said two exoskeletons based on the oscillations of yoke 70, according to the anatomical features of the patient subject to therapy and to the functional requirements of the same therapy.

With particular reference to FIG. 2, there are described the construction features of only one of the exoskeletons, in particular of the second exoskeleton 84, which from the functional construction point of view is identical to the first exoskeleton 82 (the reference numerals therefore are the same, too); the two exoskeletons are independent, articulated and mirror.

The single exoskeleton comprises a plate-shaped element 90 with a basically triangular shape whereto at least two horizontal guide columns 92 are fixed, in perpendicular direction, the end whereof opposite that of fixing relative to the plate-shaped element 90 is constrained to a further plate-shaped element 94 arranged parallel to the plate-shaped element 90. Said guide columns 92 allow moving the exoskeleton according to a horizontal direction, indicated by arrow K in FIG. 1, so as to automatically adapt the position of the same to the lower limbs of patient 72; the adjustment is carried out by the action of an epicycloidal motor reduction unit with screw and nut screw transmission not shown in the figures.

The plate-shaped element 90 is substantially positioned at the height of the hip zone of the patient 72.

A femoral arm 96 is hinged to the plate-shaped element 90 and, in the preferred embodiment, it comprises a femoral lever 98 hinged relative to the plate-shaped element 90 and a femoral body or slide 100 sliding in approach and removal relative to lever 98 along at least one femoral guide column 102.

The oscillatory-pivoting movement of the femoral arm 96, indicated by arrow X, is obtained by means of a first linear electrical motor 104 constrained to the plate-shaped element 90 and hinged to the femoral lever 98 of the femoral arm 96.

A femoral gear motor 106 of the epicycloidal type with screw and nut screw transmission allows realising the approach and removal motion of the femoral slide 100 relative to the femoral lever 98, so as to adjust the length of the femoral arm 96 according to the length of the femur of the patient subject to the rehabilitation treatment.

The femoral arm 96 is provided, preferably at the femoral slide 100, with at least one femoral bracket 105 that abuts the femur of patient 72 whereto it is fastened by a padded band of textile material or other known manner.

A tibial arm 108 is pivoted to the femoral arm 96 and can rotate relative to said femoral arm according to the direction indicated by arrow Y. The tibial arm 108 comprises a tibial lever 110 hinged relative to the femoral slide 100 of the femoral arm 96 and a tibial slide 112 sliding in approach/removal relative to the tibial lever 110 along at least one tibial guide column 114.

The oscillatory/pivoting movement of the tibial arm 108 according to direction Y and relative to the femoral arm 96 is obtained by means of a second linear electrical motor 116 constrained to the femoral slide 100 of the femoral arm 96 and hinged to the tibial lever 110 of the tibial arm 108.

A tibial gear motor 118 of the epicycloidal type with screw and nut screw transmission and constrained to the tibial lever 110 allows realising the translatory motion of the tibial slide 112 relative to the tibial lever 110, so as to adjust the length of the tibial arm 108 to the length of the tibia of the patient subject to the treatment.

The tibial arm 108 is provided, preferably at the tibial slide 112, with at least one tibial bracket 120 that abuts the tibia of patient 72 whereto it is fastened by a padded band of textile material or other known manner.

The single exoskeleton is further provided with an ankle arm 122 pivoted relative to the tibial slide 112 of the tibial arm 108 with oscillatory movement according to the direction indicated by arrow Z in FIG. 2; the ankle arm 122 is provided with a plantar support 124 for resting and containing the foot of patient 72.

The oscillatory movement of the ankle arm 122 relative to the tibial arm 108 is obtained by means of a third linear electrical motor 126 fixed to the tibial arm 108 and hinged to the ankle lever 122.

The plantar support 124 rests its bottom front on a motor-driven belt 128 which, when the device of the invention is not in use, is made to slide on the base plate 22 to a “hidden” position, preferably inside the second foot 20 of the base structure.

The vertical position of each exoskeleton may be adjusted by means of a further gear motor 130 of the epicycloidal type acting through vertical screw and nut screw, which allows realising the translatory vertical movement of the single exoskeleton along the first guide 30 and the second guide 32.

The robot rehabilitation device of the invention also integrates a control unit, preferably defined by an industrial computer, provided with dedicated software and with hardware supports required for the control and management of the device as well as the data that the same measures or that come from any sensors applied to the body of the patient subject to treatment and suitable for measuring any physical parameters of the patient.

The control and management software of the device of the invention further manages the test protocols the patient must be subject to, as well as the data relating to the patient's performance so as to assess the progresses thereof over time and the patient's biometrical parameters.

Moreover, the device of the invention may be connected to any known multimedia apparatus such as, for example, a virtual reality simulation system suitable for getting the patient into different and stimulating environments (walking in a park, along a mountain path, etc.).

The operation of the robot motor rehabilitation device of the present invention, described in detail hereinabove with reference to its construction elements, is explained hereinafter.

As already mentioned above, in non-usage conditions the motor-driven belt 128 is arranged inside the second foot 20 of the base structure.

The patient that must be subject to rehabilitation treatment wears bodice 74 provided with straps or braces 76, is introduced on board of the wheelchair underneath the portal, hooked to yoke 70 and lifted vertically by means of the lifting apparatus described above, while the motor-driven belt 128, once the wheelchair has been removed, is made to exit relative to the second foot 20.

With the patient not yet in contact with the motor-driven belt, both the first and the second exoskeleton are shifted in horizontal direction in approach of the lower limbs 72′ of patient 72, the exoskeleton height and the length of the single portions of the exoskeletons are adjusted to adapt them to the anatomical features of the patient's limbs and the feet are inserted in the plantar supports 124; all the adjustments of the exoskeleton height and of the length of the single portions of the same, that is, femoral arm 96 and tibial arm 108, are carried out automatically by actuating gear motors 130, 106 and 118 that adjust the structure to the parameters filed in a patient sheet.

At the same time, the linear motor 68 is actuated to adjust the position of the multiplying lever 64 through which the amount of patient's weight that must be counterbalanced by the lifting apparatus is calibrated.

Once the exoskeletons have been arranged relative to the patient and adjusted based on the anatomical features of the same, the motor-driven belt is started, the patient starts walking passively by the force imposed by the exoskeletons and gradually, the patient is lowered up to bringing his/her foot in contact with the belt.

The first linear electrical motor 104, the second linear electrical motor 116 and the third linear electrical motor 126 manage the movement of the femoral arm 96, of the tibial arm 108 and of the ankle arm 122 forcing the patient's limbs in carrying out the walking movement on the motor-driven belt.

The extent of the force impressed by the linear electrical motors depends on the patient's motor pathology and on the type of medical test protocol or test the patient is subject to during the rehabilitation therapy.

The control unit automatically manages the actuation of the single linear electrical motors.

The linear electrical motors, which move the single joints of the patient's limbs, autonomously and without the aid of external sensors detect any spontaneous activity of the patient's muscles and automatically adjust accordingly, limiting the power supplied, in order to facilitate such spontaneous movement of the patient.

In this way, the patient is forced or initially conducted in the passive walking movement through the force impressed by the linear electrical motors that actuate the femoral arm, the tibial arm and the ankle arm until he/she starts developing sufficient strength in the limb muscles to limit the force imparted by the linear electrical motors of the exoskeletons and start recovering an autonomous movement carrying out an active walk.

The presence of yoke 70 and in particular, its oscillation relative to fulcrum 73 allows the patient to carry out the walking movement in a totally natural manner, since as said yoke oscillates, it allows the natural movement of the pelvis.

Creating an optional virtual reality environment allows creating fascinating environments where the patient may be got into during the rehabilitation practice, so as to motivate and stimulate the same in carrying out the active walk.

As can be noticed from the above, the advantages achieved by the robot motor rehabilitation device of the invention are clear.

The robot motor rehabilitation device of the present invention advantageously allows carrying out the movement re-education of all the lower limbs of the individual suffering from motor pathologies or traumas in a simple and easy manner both for the patient and for the physiotherapist who controls the same patient.

The presence of linear electrical motors for the movement of the exoskeletons and of the single portions of the same coupled to the patient's limbs advantageously allows adjusting and managing the passive movement with a very accurate feedback coming from the pairs of muscles supported by each linear electrical motor and without the need of having to use external sensors for detecting motor parameters.

A further advantage is the fact that the linear electrical motors of the exoskeletons of the robot device of the invention are capable of automatically limiting the power supplied in case of spontaneous increases of the muscle activity of the patient's limbs.

A further advantage of the device of the invention is represented by the fact that in the event of a sudden movement by the patient, due for example to a muscle spasm or to a sudden force action imparted by the same patient, the control unit reports an alarm situation and the device immediately stops the operation of the linear electrical motors, setting them to an idle operating condition so as to prevent joint damages to the same patient.

A further advantage is that the device of the invention allows the pelvis movement, thus allowing carrying out a more regular and natural walk and thus the recovery of a correct position and walk.

A further advantage is represented by the fact that the first exoskeleton 82 and the second exoskeleton 84 are separate, independent of one another and can be managed autonomously with different movements and adjustment parameters; in this way it is possible to stress the muscles of the patient's lower limbs in a different way according to the particular pathological features of the same patient.

A further advantage is the fact that since the exoskeletons of the device of the invention also comprise a movable ankle arm, they also allow the forced movement of the foot and thus the motor stimulation of the same.

A further advantage is represented by the fact that the robot motor rehabilitation device of the invention has a compact and not cumbersome structure, easy to assemble and to maintain; moreover, the motor-driven belt hidden in the base structure eliminates the need of having a ramp for pushing the patient on the wheelchair on the same motor-driven belt, thus further limiting the machine overall dimensions.

A further advantage is the fact that the control unit allows storing the patient's biometrical parameters allowing an automatic and quick adjustment of the structure apparatus each time the patient is inserted in the device to carry out the rehabilitation session without the need for a device recalibration at each session.

While the invention has been described hereinbefore with particular reference to an embodiment made by way of a non-limiting example only, several changes and variations will appear clearly to a man skilled in the art in the light of the above description. This invention therefore is intended to include any changes and variations thereof falling within the spirit and the scope of the following claims.

1-12. (canceled)

13. A robot motor rehabilitation device (10), especially suitable for being used in motor rehabilitation activities on patients (72) suffering from neurological and/or orthopaedic damages of a various nature, such as the outcomes of ictus, head traumas, vertebral column injuries, as well as motor rehabilitation on patients (72) with a hip bone or knee prosthesis or suffering from other motor dysfunctions, comprising a portal structure fixed to a base structure, a motor-driven belt (128) suitable for allowing the walk of the patient (72), a bodice (74) provided with four straps or braces (76) hooked to the device structure and worn by the patient (72) for the support thereof, a first exoskeleton (82) and a second exoskeleton (84) articulated for the passive and assisted movement of the lower limbs (72′) of the patient (72) and means for lifting the patient and for the automatic and continuous control of the weight of the same, wherein said first and second exoskeletons (82, 84) are independently actuated by means of a plurality of linear electrical motors each for the independent articulation of hip, tibia and ankle and for the movement of the means for the automatic and continuous control of the weight of the lifted patient.

14. The robot rehabilitation device according to claim 13, wherein the first exoskeleton (82) and the second exoskeleton (84) comprise each a plate-shaped element (90) substantially positioned at the height of the hip zone of the patient (72), a femoral arm (96) hinged to said plate-shaped element, a tibial arm (108) pivoted to the femoral arm (96) and an ankle arm (122) pivoted relative to the tibial arm (108).

15. The robot rehabilitation device according to claim 14, wherein the plate-shaped element (90) comprises at least two guide columns (92) suitable for realizing a sliding according to a horizontal direction of the exoskeletons with the end opposite that of a fixing relative to the plate-shaped element (90) constrained to a further plate-shaped element (94) arranged parallel to the plate-shaped element (90).

16. The robot rehabilitation device according to claim 14, wherein the femoral arm (96) comprises a femoral lever (98) hinged relative to the plate-shaped element (90), a femoral body or slide (100) sliding in approach and removal relative to the femoral lever (98) along at least one femoral guide column (102), a first electric motor (104) of linear type pivoted to the plate-shaped element (90) and hinged to the femoral lever (98), a femoral gear motor (106) of the epicycloidal with screw and nut screw transmission suitable for realizing the approach and removal motion of the femoral slide (100) relative to the femoral lever (98), at least one femoral bracket (105) at the femoral slide (100) and in abutment of the femur of the patient (72).

17. The robot rehabilitation device according to claim 14, wherein the tibial arm (108) pivoted to the femoral arm (96) comprises a tibial lever (110) hinged relative to the femoral slide (100) of the femoral arm (96), a tibial slide (112) sliding in approach/removal relative to the tibial lever (110) along at least one tibial guide (114), a second electric motor (116) of the linear type pivoted to the femoral slide (100) and hinged to the tibial lever (11) suitable for realizing the oscillatory/pivoting movement of the tibial arm (108) relative to the femoral arm (96), a tibial gear motor (118) of the epicyclodial type with crew and nut screw transmission, constrained to the tibial lever (110) suitable for realizing the translatory movement of the tibial slide (112) relative to the tibial lever (110), at least one tibial bracket (120) at the tibial slide (112) and in abutment of the tibia of the patient (72).

18. The robot rehabilitation device according to claim 14, wherein the ankle arm (122) pivoted relative to the tibial slide (112) of the tibial arm (108), comprises a plantar support (124) for resting the foot of the patient (72), a third electric motor (126) of the linear type, constrained to the tibial arm (108), hinged to the ankle arm (122) and suitable for the oscillatory motion of the ankle arm (122) relative to the tibial arm (108).

19. The robot rehabilitation device according to claim 14, wherein the means for lifting the patient and for the automatic and continuous weight control of the same comprise at least one bar (62) slidingly arranged within a slot (60) obtained in longitudinal direction on the surface of two opposite and parallel shoulders (42) of a first carriage (34) and of a second carriage (36) sliding along a first guide (30) and a second guide (32) respectively fixed to a first bearing column (26) and to a second bearing column (28) arranged within the portal structure, a yoke (70) whereto the straps or braces (76) of the bodice (74) are fixed, said yoke constrained to the multiplying lever (64) and freely oscillating relative thereto by means of a connecting rod (71) and of a rotation pin or fulcrum (73), the multiplying lever (64) hinged relative to the at least one bar (62) and provided with a counterweight (66) hinged at the end opposite that of fixing relative to the yoke (70), a linear electric motor (68) hinged in the proximity of the counterweight (66) and pivoted on a support (69) afferent to the plates (38) and (40) arranged on the side of the second bearing column (28), the first carriage (34) and the second carriage (36) each provided with a hook plate (44) stabilized to the shoulder (42) and vertically moved by a crosspiece (46) provided with nut screws sliding coaxially to two vertical worm screws (48) arranged within the first and the second bearing column (26, 28), a belt transmission (52) of the toothed type fitted on two pulleys (54, 56) arranged at the top ends of the screws (48) provided with a belt tightening device (58) and actuated by means of a worm screw electric gear motor.

20. The robot rehabilitation device according to claim 13, wherein the base structure comprises a first foot (18) and a second foot (20) connected by at least one base plate (22) placed in contact with the floor and suitable for allowing the input and output sliding of the motor-driven belt (128) relative to the second foot (20).

21. The robot rehabilitation device according to claim 14, wherein the first exoskeleton (82) and the second exoskeleton (84) are connected to the yoke (70) respectively by a first tie rod (78) and a second tie rod (80), the first exoskeleton (82) and the second exoskeleton (84) comprising a third carriage (86) and a fourth carriage (88), slidingly arranged relative to the first guide (30) and to the second guide (32) each with the movement of said carriages actuated by a further gear motor (130) of the epicyclodial type.

22. The robot rehabilitation device according to claim 13, which further comprises an electrical cabinet (24), arranged in the lower side of a vertical box-shaped body (14) of the portal structure, said electrical cabinet containing the electrical and electronic components required for operating the device.

23. The robot rehabilitation device according to claim 13, which further comprises a control unit defined by an industrial computer, provided with software dedicated to the control and management of the device, of the test protocols the patient must be subject to, of the time performance-related data and of the biometric parameters of the patient himself.
